(19) United States
(12) Patent Application Publication
(10) Pub. No.: US 2020/0066250 A1
(43) Pub. Date: Feb. 27, 2020

(54) SPEECH SYNTHESIS DEVICE, SPEECH SYNTHESIS METHOD, AND COMPUTER PROGRAM PRODUCT

(71) Applicant: TOSHIBA DIGITAL SOLUTIONS CORPORATION, Kawasaki-shi (JP)

(72) Inventors: Masahiro MORITA, Yokohama (JP); Kouichirou MORI, Kawasaki (JP); Yamato OHTANI, Kawasaki (JP)

(73) Assignee: TOSHIBA DIGITAL SOLUTIONS CORPORATION, Kawasaki-shi (JP)

(21) Appl. No.: 16/561,584

(22) Filed: Sep. 5, 2019

Related U.S. Application Data
(63) Continuation of application No. PCT/JP2017/034648, filed on Sep. 26, 2017.

(30) Foreign Application Priority Data
Mar. 15, 2017 (JP) 2017-049801

(51) Int. Cl. G10L 13/033; G10L 13/047; G06Q 30/02

(52) U.S. Cl. CPC G10L 13/033; G06Q 30/0283; G10L 13/047

(57) ABSTRACT

A speech synthesis device according to an embodiment includes a speech synthesizing unit, a speaker parameter storing unit, an availability determining unit, and a speaker parameter control unit. Based on a speaker parameter value representing a set of values of parameters related to the speaker individuality, the speech synthesizing unit is capable of controlling the speaker individuality of synthesized speech. The speaker parameter storing unit is used to store already-registered speaker parameter values. Based on the result of comparing an input speaker parameter value with each already-registered speaker parameter value, the availability determining unit determines the availability of the input speaker parameter value. The speaker parameter control unit prohibits or restricts the use of the input speaker parameter value that is determined to be unavailable by the availability determining unit.

### CROSS-REFERENCE TO RELATED APPLICATIONS

This application is a continuation of PCT International Application No. PCT/JP2017/034648 filed on Sep. 26, 2017, which designates the United States, incorporated herein by reference. The PCT International Application No. PCT/JP2017/034648 claims the benefit of priority from Japanese Patent Application No. 2017-049801, filed on Mar. 15, 2017, incorporated herein by reference.

### FIELD

Embodiments described herein relate generally to a speech synthesis device, a speech synthesis method, and a computer program product.

### BACKGROUND

In speech synthesis, regarding the speaker of synthetic speech to be generated, aside from selecting a speaker from a small number of candidates provided in advance, there is a demand for newly creating the speaker individuality that is suitable for the contents to be read or for newly creating the speaker individuality that is unique to the user. As a way to meet such a demand, for example, a technology has been proposed that enables creation of new speaker individualities by manipulating the parameters related to speaker individuality.

Along with the sophistication of such technology, if users become able to freely create various speaker individualities having a high degree of originality, it is expected to see a rise in the demand for exclusively using the newly-created speaker individuality as one's own distinctive speaker individuality. However, such a demand cannot be met, because there may be cases in which speaker individuality, which is identical or similar to the speaker individuality created by a particular user speaker individuality, is accidentally created by another user and is used in actual products/services.

### BRIEF DESCRIPTION OF THE DRAWINGS

FIG. 1 is a block diagram illustrating an exemplary functional configuration of a speech synthesis device according to a first embodiment;

FIG. 2 is a block diagram illustrating an exemplary configuration of a speech synthesizing unit and a speech synthesis model storing unit;

FIG. 3 is a diagram illustrating a specific example of converting a speaker parameter value into weights of sub-models;

FIG. 4 is a diagram illustrating an example of information stored in a speaker parameter storing unit;

FIG. 5 is a flowchart for explaining an exemplary flow of operations performed by an availability determining unit;

FIGS. 6 to 11 are diagrams illustrating exemplary screen configurations of a user interface;

FIG. 12 is a block diagram illustrating an exemplary functional configuration of the speech synthesis device according to a second embodiment;

FIGS. 13A and 13B are conceptual diagrams for illustrating the difference between availability determination and registrability determination;

FIGS. 14 to 18 are diagrams illustrating exemplary screen configurations of a user interface; and

FIG. 19 is a block diagram of an exemplary hardware configuration of the speech synthesis device.

### DETAILED DESCRIPTION

A speech synthesis device according to an embodiment includes a speech synthesizing unit, a speaker parameter storing unit, an availability determining unit, and a speaker parameter control unit. Based on a speaker parameter value representing a set of values of parameters related to the speaker individuality, the speech synthesizing unit is capable of controlling the speaker individuality of synthesized speech. The speaker parameter storing unit is used to store already-registered speaker parameter values. Based on the result of comparing an input speaker parameter value with each already-registered speaker parameter value, the availability determining unit determines the availability of the input speaker parameter value. The speaker parameter control unit prohibits or restricts the use of the input speaker parameter value that is determined to be unavailable (unusable) by the availability determining unit.

Exemplary embodiments of a speech synthesis device, a speech synthesis method, and a computer program product are described below in detail with reference to the accompanying drawings. In the following explanation, the constituent elements having identical functions are referred to by the same reference numerals, and the redundant explanation is not repeated.

### First Embodiment

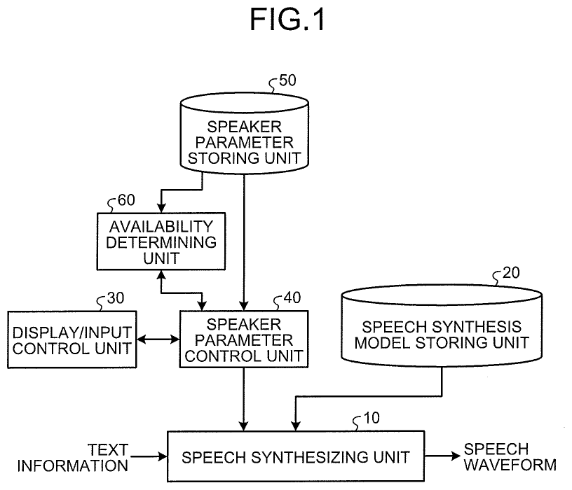

FIG. 1 is a block diagram illustrating an exemplary functional configuration of a speech synthesis device according to a first embodiment. As illustrated in FIG. 1, the speech synthesis device according to the first embodiment includes a speech synthesizing unit 10, a speech synthesis model storing unit 20, a display/input control unit 30, a speaker parameter control unit 40, a speaker parameter storing unit 50, and an availability determining unit 60.

The speech synthesizing unit 10 receives input of text information, and generates a speech waveform of the synthetic speech using various models and rules stored in the speech synthesis model storing unit 20. At that time, if a speaker parameter value representing the values of the parameters related to the speaker individuality is also input from the speaker parameter control unit 40, then the speech synthesizing unit 10 generates a speech waveform while controlling the speaker individuality according to the input speaker parameter value. The speaker individuality represents the features of the voice unique to the speaker and, for example, has a plurality of factors such as age, brightness, hardness, and clarity. The speaker parameter value represents the set of values corresponding to such factors of the speaker individuality.

The speech synthesis model storing unit 20 is used to store an acoustic model formed by modeling the acoustic features of speech; a prosody model formed by modeling the prosody such as intonation/rhythm; and a variety of other information required in speech synthesis. Moreover, in the speech synthesis device according to the first embodiment, a model required in controlling the speaker individuality is also stored in the speech synthesis model storing unit 20.

In a speech synthesis method based on the hidden Markov model (HMM), the prosody model and the acoustic model stored in the speech synthesis model storing unit 20 are formed by modeling the correspondence relationship between text information, which is extracted from texts, and the parameter sequence of prosody or acoustic. Generally, the text information is configured with phonological information, which corresponds to the manner of reading a text and the accent, and language information such as separation of phrases and the part of speech. A model is configured with: a decision tree in which each parameter is clustered on a state-by-state basis according to the phonological/language environment; and the probability distribution of parameters assigned to each leaf node of the decision tree.

The prosody parameters include a pitch parameter indicating the pitch of the voice and the duration length indicating the length of the sound. The acoustic parameters include a spectral parameter indicating the features of the vocal tract and an aperiodic index indicating the extent of aperiodicity of the source signal. Herein, a state implies the internal state attained when the temporal change of each parameter is modeled using the HMM. Usually, since each phoneme section is modeled using the HMM of three to five states that make transition from left to right without any back tracking, the phoneme section includes three to five states. Herein, for example, in the decision tree for the first state of the pitch parameter, the probability distribution of the pitch values in the leading section of the phoneme sections is subjected to clustering according to the phonological/language environment and, by tracing the decision tree based on the phonological/language information related to the target phoneme section, the probability distribution of the pitch parameter of the leading section of those phonemes can be obtained. It is often the case that the normal distribution is used as the probability distribution of parameters and, in that case, the distribution is expressed using the average vector, which represents the center of the distribution, and the covariance matrix, which indicates the spread of the distribution.

In the speech synthesizing unit 10, based on the input text information, the probability distribution with respect to each state of each parameter is selected in the decision tree described above; parameter sequences having the highest probability are generated based on the probability distributions; and a speech waveform is generated based on those parameter sequences. In the case of the method based on the general HMM, a source waveform is generated based on the generated pitch parameters and the aperiodic index, and then a speech waveform is generated by convoluting, in the source waveform, a vocal tract filter that undergoes temporal changes in the filter characteristics according to the generated spectral parameters.

In the speech synthesizing unit 10 of the speech synthesis device according to the first embodiment, the speaker individuality can be controlled as a result of specification of the speaker parameter value by the speaker parameter control unit 40. As a method for implementing that control, for example, as disclosed in Patent Literature 1, the desired speaker individuality can be achieved as follows: a plurality of acoustic models formed by modeling the voices of a plurality of speakers having different voice qualities is stored in the speech synthesis model storing unit 20; a few of the acoustic models are selected according to the specified speaker parameter value; and the acoustic parameters of the selected acoustic models are interpolated using the weighted sum.

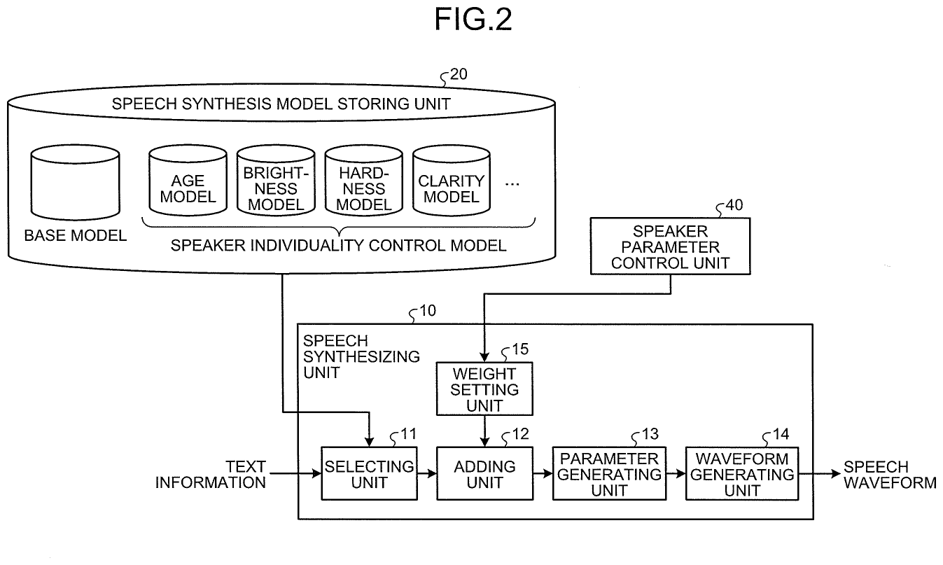

Alternatively, the control of the speaker individuality can be implemented using the speech synthesizing unit 10 and the speech synthesis model storing unit 20 having a configuration as illustrated in FIG. 2. In the configuration illustrated in FIG. 2, the speech synthesis model storing unit 20 is used to store a base model obtained by modeling the prosody/voice quality of the base speaker individuality, and to store a speaker individuality control model obtained by modeling the differences in the prosody/acoustic parameters attributed to the differences in the factors of the speaker individuality.

The base model can be a model called an average voice model that expresses the average speaker individuality of a plurality of speakers, or can be a model that expresses the speaker individuality of a particular speaker. As far as the specific configuration of the base model is concerned, for example, in an identical manner to the prosody model or the acoustic model obtained according to the method based on the HMM, the base model is configured with: a decision tree in which each parameter is clustered on a state-by-state basis according to the phonological/language environment; and the probability distribution of parameters assigned to each leaf node of the decision tree.

The speaker individuality control model can also be configured with a decision tree and the probability distribution assigned to each leaf node of the decision tree. However, in this model, the probability distribution represents the differences in the prosody/acoustic parameters attributed to the differences in the factors of the speaker individuality. More particularly, in this model, following sub-models are included: an age model obtained by modeling the differences in the prosody/acoustic parameters attributed to the differences in the age; a brightness model obtained by modeling the differences in the prosody/acoustic parameters attributed to the differences in the brightness of voice; a hardness model obtained by modeling the differences in the prosody/acoustic parameters attributed to the differences in the hardness of voice; and a clarity model obtained by modeling the differences in the prosody/acoustic parameters attributed to the differences in the clarity of voice.

The speech synthesizing unit 10 having the configuration illustrated in FIG. 2 includes a selecting unit 11, an adding unit 12, a parameter generating unit 13, a waveform generating unit 14, and a weight setting unit 15. The selecting unit 11 selects, based on the input text information, the probability distributions from the base model and the sub-models of the speaker individuality control model using the decision tree. The adding unit 12 adds, in a weighted manner, the average value of the probability distributions selected by the selecting unit 11 according to the weight of each sub-model as assigned by the weight setting unit 15; uses the dispersion of the base model; and obtains the probability distribution in which the speaker individuality control model is reflected.

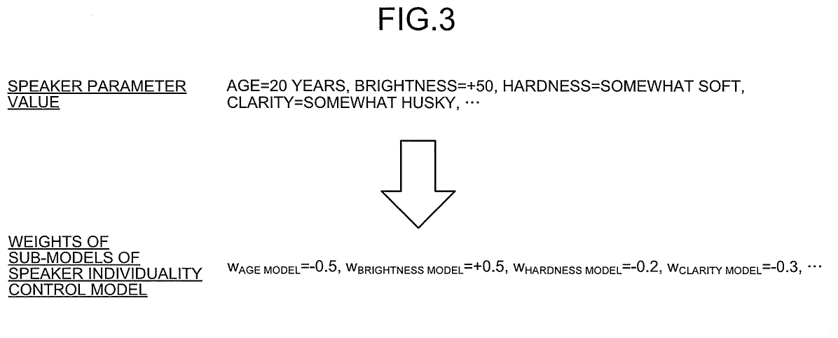

Herein, the weight of a sub-model is obtained by the weight setting unit 15 by conversion of the speaker parameter value assigned by the speaker parameter control unit 40. A specific example is illustrated in FIG. 3. In this example, regarding the speaker parameter value as well as the weights of the sub-models, although each element corresponds to each sub-model of the speaker individuality control model, the method of expressing the values is different. Parameter values in the speaker parameter value are either continuous values or have a discrete category depending on the elements. Moreover, the range of values is different for each element; the weight of each sub-model is a continuous value; and the range of values is normalized between −1.0 and 1.0. However, that is not the only possible method of expressing the parameter values in the speaker parameter value and the values of the weights of the sub-models, and the two types of values need not always be different.

The adding unit 12 performs the abovementioned addition operation in each state of each parameter, and generates a sequence of probability distributions for which a weighted addition is performed.

Regarding each parameter such as the spectral parameter and the pitch parameter, based on the sequence of probability distributions assigned by the adding unit 12, the parameter generating unit 13 generates a parameter sequence having the maximum probability. Based on the generated parameter sequence, the waveform generating unit 14 generates a speech waveform of the synthetic speech.

As described above, the speech synthesizing unit 10 having the configuration illustrated in FIG. 2 can freely control the speaker individuality according to the speaker parameter value specified in the speaker parameter control unit 40.

Returning to the explanation with reference to FIG. 1, the display/input control unit 30 visualizes and displays the speaker parameter value that are set in the speaker parameter control unit 40, and provides to the users a user interface that enables the users to change/input the parameter values of the speaker parameter value. When a user makes use of the user interface and changes/inputs the speaker parameter value, the display/input control unit 30 sends the speaker parameter value corresponding to the user operation to the speaker parameter control unit 40. Moreover, when information related to the prohibition of use of the speaker parameter value or related to the restrictions on the speaker parameter value is sent back from the speaker parameter control unit 40, the display/input control unit 30 notifies the user about those details via the user interface. Furthermore, regarding a user who holds already-registered speaker parameter values stored in the speaker parameter storing unit 50, when the information enabling identification of the user (user information) is input, an instruction for calling the corresponding speaker parameter values from the speaker parameter storing unit 50 can also be given. Regarding a specific example of the user interface, the details are given later.

The speaker parameter control unit 40 performs operations related to the speaker parameter value in coordination with the display/input control unit 30 and the availability determining unit 60. For example, when the speaker parameter value that is input by the user are received from the display/input control unit 30, the speaker parameter control unit 40 sends speaker parameter value and the user information to the availability determining unit 60 and instructs determination about the availability of the speaker parameter value. If the speaker parameter value that is input is determined to be available (usable), then the speaker parameter control unit 40 sends the speaker parameter value to the speech synthesizing unit 10 and enables their use in speech synthesis. On the other hand, if it is determined that the speaker parameter value that is input by the user is unavailable, then the speaker parameter control unit 40 prohibits or restricts the use of those speaker parameters and sends information about the prohibition of use or restriction on use to the display/input control unit 30. Herein, restriction on use implies that the use is allowed with an condition. Meanwhile, when an instruction for calling the already-registered speaker parameter values is given by the display/input control unit 30, the speaker parameter control unit 40 identifies the user and retrieves the corresponding already-registered speaker parameter values from the speaker parameter storing unit 50, and sends them to the display/input control unit 30 or the speech synthesizing unit 10.

The speaker parameter storing unit 50 is used to store the already-registered speaker parameter values that are held by each user. In the first embodiment, it is assumed that the speaker parameter values are registered by some other device other than the speech synthesis device illustrated in FIG. 1, and that the already-registered speaker parameter values are stored in the speaker parameter storing unit 50. When a speaker parameter value gets registered, the already-registered speaker parameter value along with related supplementary information gets stored in the speaker parameter storing unit 50.

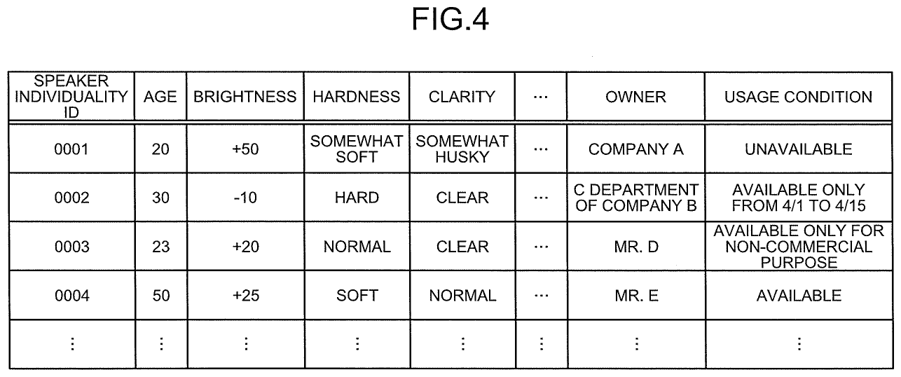

In FIG. 4 is illustrated an example of the information stored in the speaker parameter storing unit 50. In FIG. 4, the columns indicate the already-registered speaker parameter values and the corresponding supplementary information. Thus, each already-registered speaker parameter value has a speaker individuality ID representing identification information uniquely assigned thereto, and the values of the factors of the speaker individuality constituting that already-registered speaker parameter value are stored along with the supplementary information such as the owner of that already-registered speaker parameter value and the usage condition of that already-registered speaker parameter value. The owner can be a group such as a company or a department as illustrated in the case of the already-registered speaker parameter values having the speaker individuality IDs of 0001 and 0002, or can be an individual person as illustrated in the case of the already-registered speaker parameter values having the speaker individual IDs of 0003 and 0004. Regarding the usage condition, there can be many settings such as disallowing any use other than the use by the owner as illustrated in the case of the already-registered speaker parameter value having the speaker individuality ID of 0001, or allowing the use only for a specific period or depending on the usage as illustrated in the case of the already-registered speaker parameter values having the speaker individuality IDs of 0002 and 0003. Moreover, in order to prevent a situation of not being able to use an already-registered speaker parameter value because it is held by some other owner, the already-registered speaker parameter value can be held without setting any usage restrictions as illustrated in the case of the already-registered speaker parameter value having the speaker individuality ID of 0004.

The availability determining unit 60 receives from the speaker parameter control unit 40 the input of speaker parameter value and user information as input by a user; collates the input information with the already-registered speaker parameter values and the supplementary information; and determines the availability of the input speaker parameter value and sends the determination result to the speaker parameter control unit 40.

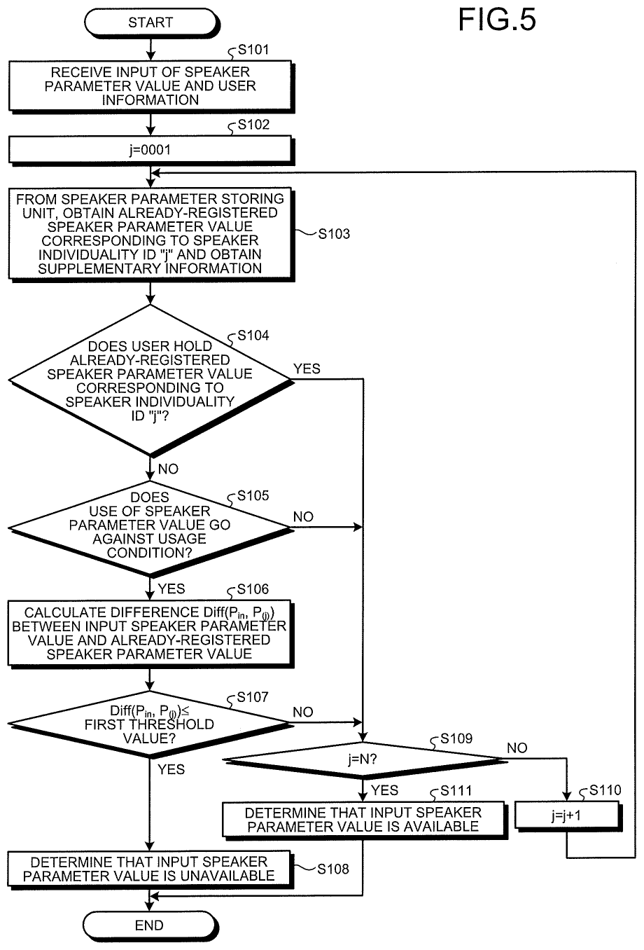

Explained below with reference to FIG. 5 is an exemplary determination method implemented by the availability determining unit 60. FIG. 5 is a flowchart for explaining an exemplary flow of operations performed by the availability determining unit 60. When a speaker parameter value (Pᵢₙ={pᵢₙ⁽⁰⁾, pᵢₙ⁽¹⁾, pᵢₙ⁽²⁾, . . . , pᵢₙ^{(C-1)}}, where Pᵢₙ^{(k)} represents the value of the k-th element and C represents the number of elements) and the user information as input by a user are received from the speaker parameter control unit 40 (Step S101), the availability determining unit 60 sets a counter j of the speaker individuality ID to the initial already-registered speaker parameter value (in this example, j=0001) (Step S102).

Subsequently, the availability determining unit 60 refers to the speaker parameter storing unit 50 and obtains the already-registered speaker parameter value and the supplementary information for the speaker individuality ID “j” (Step S103). Then, the system control proceeds to Step S104. Herein, regarding the speaker individuality ID “j”, the speaker parameter value is assumed to be P₍ⱼ₎={pⱼ⁽⁰⁾, pⱼ⁽¹⁾, pⱼ⁽²⁾, . . . , pⱼ^{(C-1)}}. Meanwhile, N represents the total number of already-registered speaker parameter values that are stored in the speaker parameter storing unit 50.

At Step S104, based on the user information obtained at Step S101 and the supplementary information obtained at Step S103, the availability determining unit 60 determines whether or not the user who inputs the speaker parameter value is the owner of the already-registered speaker parameter value corresponding to the speaker individuality ID “j” (Step S104). If the user who inputs the speaker parameter value is the owner of the already-registered speaker parameter value corresponding to the speaker individuality ID “j” (Yes at Step S104), then the system control proceeds to Step S109. On the other hand, if the user who inputs the speaker parameter value is not the owner of the already-registered speaker parameter value corresponding to the speaker individuality ID “j” (No at Step S104), then the system control proceeds to Step S105.

At Step S105, based on the supplementary information obtained at Step S103, the availability determining unit 60 determines whether or not the use of the speaker parameter value by the user goes against the usage condition set for the already-registered speaker parameter value corresponding to the speaker individuality ID “j” (Step S105). If the use does not go against the usage condition (No at Step S105), then the system control proceeds to Step S109. However, if the use goes against the usage condition (Yes at Step S105), then the system control proceeds to Step S106. The determination method for determining whether or not the use is against the usage condition set for the already-registered speaker parameter value is different depending on the usage condition for the already-registered speaker parameter value that is stored as supplementary information in the speaker parameter storing unit 50. For example, for the already-registered speaker parameter value corresponding to the speaker individuality ID “j”, if the usage condition is set to unavailable, then it is determined that the use goes against the usage condition. Moreover, regarding the already-registered speaker parameter value corresponding to the speaker individuality ID “j”, if the usage condition indicates that the use is allowed only for a predetermined period of time; then, for example, as long as the current timing is within that predetermined period of time, it is determined that the use does not go against the usage condition. However, if the current timing is outside of the predetermined period of time, then it is determined that the use goes against the usage condition.

At Step S106, from the speaker parameter value received at Step S101 (i.e., the speaker parameter value input by the user) and from the already-registered speaker parameter value obtained at Step S103 (i.e., the already-registered speaker parameter value corresponding to the speaker individuality ID “j”), the availability determining unit 60 calculates a Diff(Pᵢₙ, P₍ⱼ₎), which represents the difference between the two speaker parameter values, using a predetermined evaluation function. Then, the system control proceeds to Step S107.

At Step S107, the availability determining unit 60 compares the value of Diff(Pᵢₙ, P₍ⱼ₎) calculated at Step S106 with a first threshold value representing a boundary of the range of already-registered speaker parameter values. If the value of Diff(Pᵢₙ, P₍ⱼ₎) is equal to or smaller than the first threshold value (Yes at Step S107), that is, if the speaker parameter value input by the user is similar to the already-registered speaker parameter value corresponding to the speaker individuality ID “j”, then the availability determining unit 60 determines at Step S108 that the speaker parameter value input by the user is “unavailable” and sends the determination result to the speaker parameter control unit 40. It marks the end of the operations. On the other hand, if the value of Diff (Pᵢₙ, P₍ⱼ₎) is greater than the first threshold value (No at Step S107), then the system control proceeds to Step S109.

At Step S109, the availability determining unit 60 checks whether j=N holds true, that is, checks whether collation has completed for all already-registered speaker parameter values and supplementary information stored in the speaker parameter storing unit 50. If j=N does not hold true (No at Step S109), then the availability determining unit 60 increments the counter j of the speaker individuality ID at Step S110, and again performs the operations from Step S103 onward. On the other hand, if j=N (Yes at Step S109), at Step S111, the availability determining unit 60 determines that the speaker parameter value input by the user is “available” and sends the determination result to the speaker parameter control unit 40. It marks the end of the operations.

Given below is the explanation about the difference Diff(P₁, P₂) that is used at Step S106 as the difference between two speaker parameter values P₁ and P₂. For example, as given below in Equation (1), Diff(P₁, P₂) can be defined as the weighted sum of the difference of each factor of the speaker individuality that constitutes the speaker parameter value.

$$Diff ( {P}_{1} , {P}_{2} ) = {\sum }_{k = 0}^{C - 1} \{ {λ}^{\{ k )} \cdot {d}^{( k )} ( {p}_{1}^{( k )} , {p}_{2}^{( k )} ) \} \qquad ( 1 )$$

Where, P₁ is represented as {p₁⁽⁰⁾, p₁⁽¹⁾, p₁⁽²⁾, . . . , p₁^{(C-1)}} and P₂ is represented as {p₂⁽⁰⁾, p₂⁽¹⁾, p₂⁽²⁾, . . . p₂^{(C-1)}}. Moreover, λ^{(k)} represents the weight of the k-th element, and d^{(k)} represents the difference at the k-th element. Regarding an element expressed as a continuous value, d^{(k)} (p₁^{(k)}, p₂^{(k)}) can be defined as the square error of p₁^{(k)} and p₂^{(k)}. Regarding an element expressed as a discrete category, d^{(k)} (p₁^{(k)}, p₂^{(k)}) can be defined as “0” if p₁^{(k)} and p₂^{(k)} are identical and can be defined as “1” otherwise. Regarding the weight λ^{(k)}, it is desirable that the elements that have a large effect on the subjective differences in the speaker individualities have a proportionally large weight. For example, it is possible to think of performing subjective assessment of the differences in the speaker individualities in the speeches generated by combining various P₁ and P₂, and the result thereof is subjected to multiple linear regression analysis, so that the relationship between d⁽⁰⁾ (p₁⁽⁰⁾, p₂⁽⁰⁾, . . . , d^{(c-1)} (p₁^{(C-1)}, p₂^{(C-1)}) and the subjective assessment value is obtained; and using the coefficient of the resultant multiple linear equation as the weight.

Regarding the example of Diff(P₁, P₂), it is assumed that each element independently affects the differences in the speaker individualities. However, from the data of a large number of combinations of d⁽⁰⁾ (p₁⁽⁰⁾, p₂⁽⁰⁾, . . . , d^{(c-1)} (p₁^{(C-1)}, p₂^{(C-1)}) and the subjective assessment value as obtained by performing the abovementioned subjective assessment in high volume, if a neural network for estimating the difference Diff(P₁, P₂) is learnt using a deep learning method, then it becomes possible to estimate the difference Diff(P₁, P₂) in which the mutual action among the elements is also reflected to some extent.

The first threshold value that is used in the determination at Step S107 either can be a common value for all already-registered speaker parameter values stored in the speaker parameter storing unit 50 or can be a different value for each already-registered speaker parameter value. In the latter case, the supplementary information stored in the speaker parameter storing unit 50 not only contains the information about the owners and the usage condition but also contains the first-type threshold values indicating the registration ranges of the already-registered speaker parameter values. For example, if an owner wishes to exclusively use a particular already-registered speaker parameter value over a wider range, he or she can register a larger first threshold value corresponding to that already-registered speaker parameter value so that the range determined to be unavailable can be widened.

Given below is the explanation of an example of the interactive operations performed by the speech synthesis device in response to the user operations, along with explaining a specific example of the user interface that is provided by the display/input control unit 30 to the user.

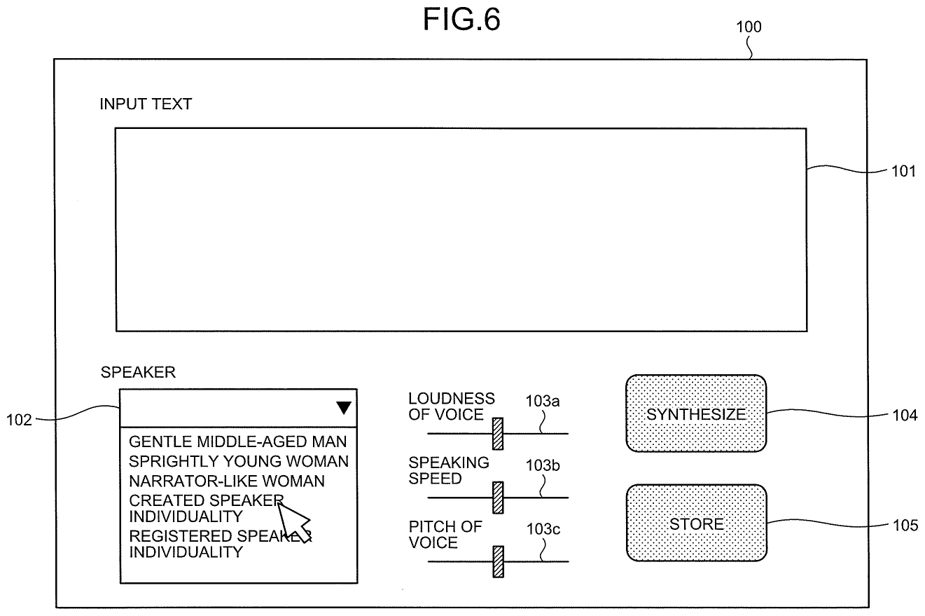

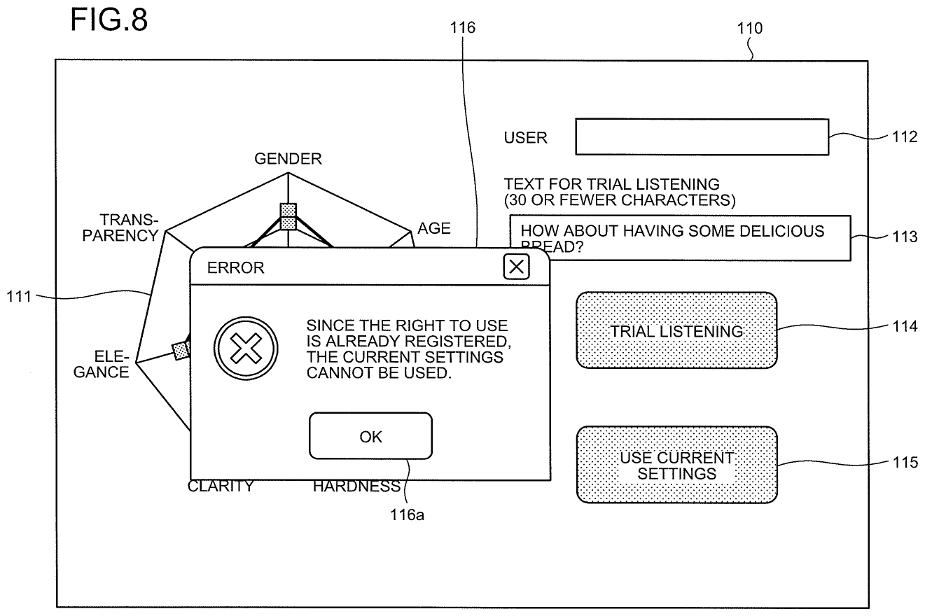

FIGS. 6 to 11 are diagrams illustrating exemplary screen configurations of the user interface provided by the display/input control unit 30 to the user. The screens illustrated in FIGS. 6 to 11 are displayed by the display/input control unit 30 as, for example, screens capable of receiving input operations performed using input devices such as a keyboard and a mouse. Meanwhile, the user interface illustrated herein is only exemplary, and can be modified or changed in various ways. As long as the user interface that is provided by the display/input control unit 30 has a configuration enabling the user to input the desired speaker parameter value, it serves the purpose.

Once the speech synthesis device according to the first embodiment is activated and when a user performs login according to a predetermined procedure; for example, a screen 100 illustrated in FIG. 6 is displayed in the display device that is connected to the speech synthesis device or in the display device of the user terminal. The screen 100 illustrated in FIG. 6 includes a text box 101 for inputting the text information to be subjected to speech synthesis; a pulldown menu 102 for selecting the speaker individuality to be used; slide bars 103a, 103b, and 103c for setting general voice quality parameters such as the loudness of voice, the speaking speed, and the pitch of voice; a “synthesize” button 104 for instructing the generation of a speech waveform of the synthetic speech; and a “store” button 105 for instructing the storage of the generated speech waveform of the synthetic speech. In the pulldown menu 102, other than the typical speaker individualities that are provided in advance, the following options are also provided: an option “created speaker individuality” for using the speaker individuality created by the user; and an option “registered speaker individuality” for using a speaker individuality created and registered in the past by the user.

From the pulldown menu 102 of the screen 100 illustrated in FIG. 6, when a typical speaker individuality such as “a gentle middle-aged man”, “a sprightly young woman”, or “a narrator-like woman” that is provided in advance is selected, the user can perform operations on the screen 100 and obtain a speech waveform of the synthetic speech to which the speaker parameter value corresponding to the selected speaker individuality is applied. That is, the user inputs in the text box 101 the text information to be subjected to speech synthesis, adjusts the voice quality parameters by operating the slide bars 103a, 103b, and 103c as may be necessary, and then presses the “synthesize” button 104. As a result, a speech waveform of the synthetic speech to which the speaker parameter value corresponding to the selected speaker individuality is applied gets generated by the speech synthesizing unit 10. Moreover, if the user presses the “store” button 105, the speech waveform of the synthetic speech as generated by the speech synthesizing unit 10 gets stored at a predetermined storage location.

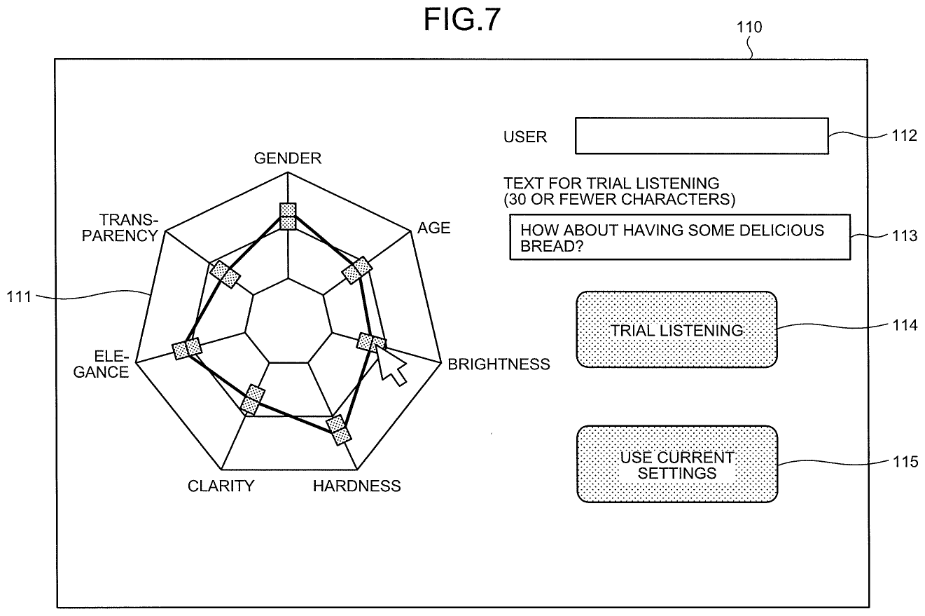

Meanwhile, from the pulldown menu 102 of the screen 100 illustrated in FIG. 6, if the user performs an operation for selecting the “created speaker individuality”, the screen 100 illustrated in FIG. 6 changes to a screen 110 illustrated in FIG. 7. The screen 110 illustrated in FIG. 7 enables the user to input the desired speaker parameter value, and includes the following: a radar chart 111 that visualizes the speaker parameter value; a text box 112 for inputting the user information; a text box 113 for inputting a text for trial listening; a “trial listening” button 114 for requesting trial listening of the synthetic speech of the text for trial listening as obtained using the speaker parameter value illustrated in the radar chart 111; and a “use current settings” button 115 for instructing the use of the speaker parameter value illustrated in the radar chart 111 in speech synthesis.

The radar chart 111 has, on the axis corresponding to each factor of the speaker individuality, an operator for changing the value corresponding to that factor. The user can operate the operators provided on the radar chart 111 and input the desired speaker parameter value. The synthetic speech in which the input speaker parameter value is reflected can be checked by inputting a text for trial listening in the text box 113 and pressing the “trial listening” button 114.

Moreover, after inputting the desired speaker parameter value using the radar chart 111, when the user inputs the user information in the text box 112 and presses the “use current settings” button 115, the speaker parameter value and the user information as input by the user gets transferred from the display/input control unit 30 to the speaker parameter control unit 40. Upon receiving the speaker parameter value and the user information from the display/input control unit 30, the speaker parameter control unit 40 sends the speaker parameter value and the user information to the availability determining unit 60 and requests for availability determination. Then, the availability determining unit 60 implements, for example, the method described earlier to determine the availability of the speaker parameter value input by the user, and sends the determination result to the speaker parameter control unit 40.

If the determination result obtained by the availability determining unit 60 indicates unavailability, then the speaker parameter control unit 40 sends information related to the prohibition of use or restriction on use to the display/input control unit 30. Then, the display/input control unit 30 reflects the information, which is received from the speaker parameter control unit 40, on the screen of the user interface. For example, when the information related to the prohibition of use is received from the speaker parameter control unit 40, the display/input control unit 30 displays, on the screen 110, a popup error message 116 notifying the user that the input speaker parameter value is not available. When an “OK” button 116a provided in the error message 116 is pressed, the display returns to the screen 110 illustrated in FIG. 7. Moreover, when information related to the restriction on use is received from the speaker parameter control unit 40, then the display/input control unit 30 can display, on the screen 110, a popup alert message notifying the user about the condition under which the speaker parameter value is available, such as the speaker parameter value is available only for a predetermined period of time or only for a non-commercial purpose.

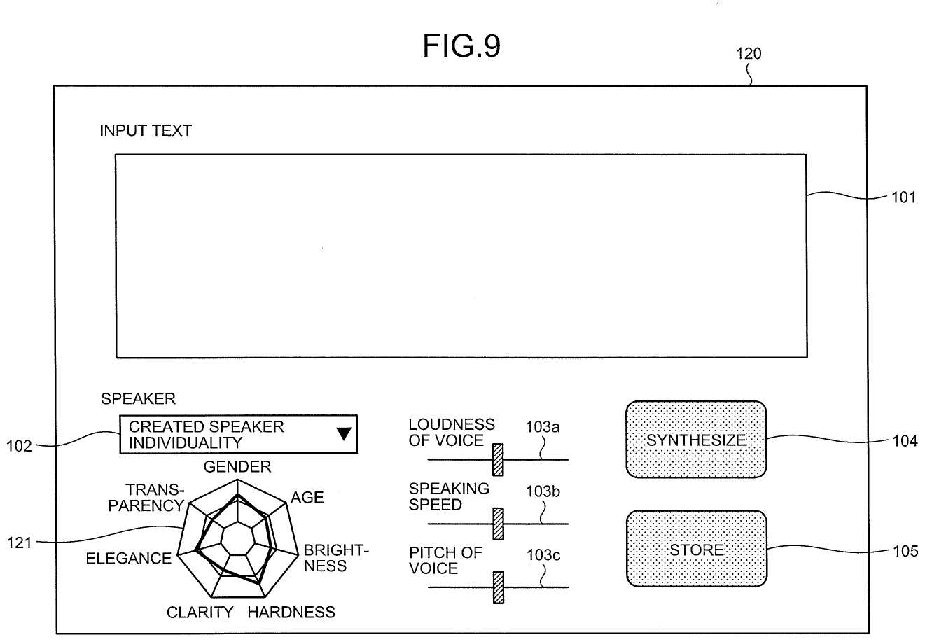

Meanwhile, if the determination result obtained by the availability determining unit 60 indicates availability, then the screen of the interface changes from the screen 110 illustrated in FIG. 7 to a screen 120 illustrated in FIG. 9. The screen 120 illustrated in FIG. 9 has an identical fundamental configuration to the screen 100 illustrated in FIG. 6. Herein, in the screen 120 illustrated in FIG. 9, the selected option of “created speaker individuality” is displayed in the pulldown menu 102, and a thumbnail 121 of the radar chart corresponding to the speaker parameter value determined to be available is displayed below the pulldown menu 102.

Using the screen 120, the user inputs in the text box 101 the text information to be subjected to speech synthesis, adjusts the voice quality parameters by operating the slide bars 103a, 103b, and 103c as may be necessary, and then presses the “synthesize” button 104. As a result, a speech waveform of the synthetic speech to which the speaker parameter value input by the user is applied gets generated by the speech synthesizing unit 10. Moreover, if the user presses the “store” button 105, the speech waveform of the synthetic speech as generated by the speech synthesizing unit 10 gets stored at a predetermined storage location.

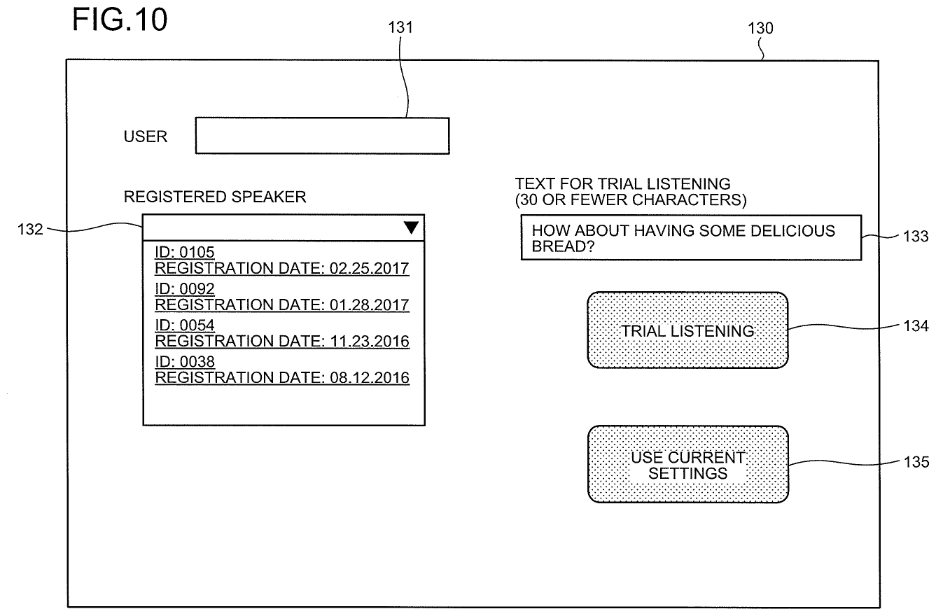

Meanwhile, if the user performs an operation for selecting the option of “registered speaker individuality” from the pulldown menu 102 of the screen 100 illustrated in FIG. 6, the screen 100 illustrated in FIG. 6 changes to a screen 130 illustrated in FIG. 10. The screen 130 illustrated in FIG. 10 includes the following: a text box 131 for inputting the user information; a pulldown menu 132 for selecting the already-registered speaker parameter values held by the user; a text box 133 for inputting a text for trial listening; a “trial listening” button 134 for requesting trial listening of the synthetic speech of the text for trial listening as obtained using an already-registered speaker parameter value selected in the pulldown menu 132; and a “use current settings” button 135 for instructing the use of the speaker parameter value selected in the pulldown menu 132 in speech synthesis.

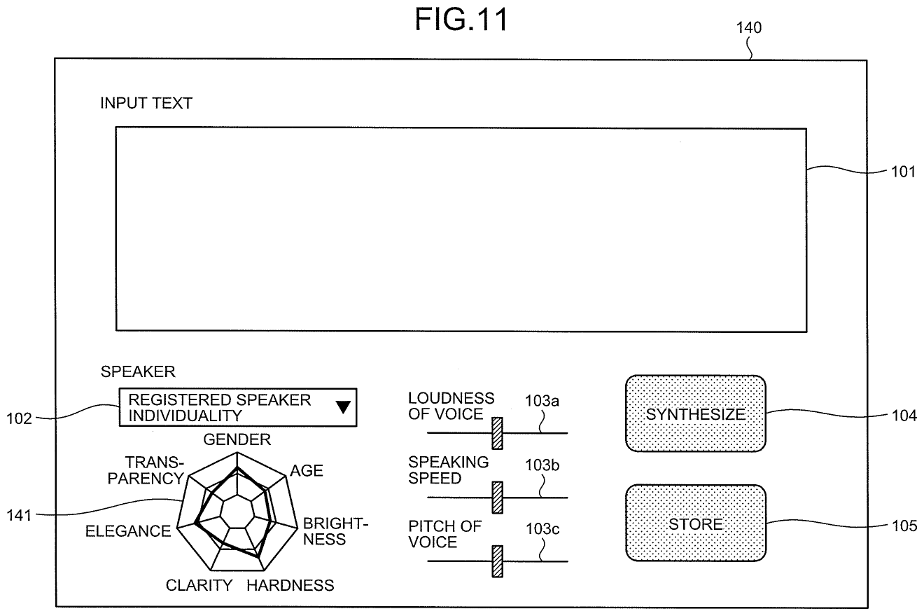

When a user inputs the user information in the text box 131, a list of the already-registered speaker parameter values held by that user is displayed in a selectable manner. Subsequently, when the user selects the desired already-registered speaker parameter value from the pulldown menu 132, selects a text for trial listening in the text box 133, and presses the “trial listening” button 134; he or she becomes able to check the synthetic speech in which the selected already-registered speaker parameter value is reflected. Moreover, after selecting the desired already-registered speaker parameter value from the pulldown menu 132, when the user presses the “use current settings” button 135, the already-registered speaker parameter value that is selected by the user is set in the speaker parameter control unit 40, and the screen 130 illustrated in FIG. 10 changes to a screen 140 illustrated in FIG. 11. The screen 140 illustrated in FIG. 11 has an identical fundamental configuration to the screen 100 illustrated in FIG. 6. Herein, in the screen 140 illustrated in FIG. 11, the selected option of “registered speaker individuality” is displayed in the pulldown menu 102, and a thumbnail 141 of the radar chart corresponding to the selected already-registered speaker parameter value is displayed below the pulldown menu 102.

Using the screen 140, the user inputs in the text box 101 the text information to be subjected to speech synthesis, adjusts the voice quality parameters by operating the slide bars 103a, 103b, and 103c as may be necessary, and then presses the “synthesize” button 104. As a result, a speech waveform of the synthetic speech to which the already-registered speaker parameter value selected by the user is applied gets generated by the speech synthesizing unit 10. Moreover, if the user presses the “store” button 105, the speech waveform of the synthetic speech as generated by the speech synthesizing unit 10 gets stored at a predetermined storage location.

Meanwhile, the explanation above is given about an example in which an already-registered speaker parameter value is selected and used without modification. Alternatively, the selected already-registered speaker parameter value can be further adjusted in the screen 110, which is illustrated in FIG. 7, before using it. In that case, since there is a possibility that the usage condition differs than in the case of using the already-registered speaker parameter value that was originally selected, the availability determination is again performed using the post-adjustment speaker parameter value, before deciding on the final availability.

In this way, as described above in detail with reference to specific examples, according to the first embodiment, based on the result of comparison of the input speaker parameter value with the already-registered speaker parameter values, the availability of the input speaker parameter value is determined and the speaker parameter value determined to be unavailable is prohibited or restricted for use. Hence, when the speaker parameter value representing the desired speaker individuality is registered, it becomes possible to exclusively use that desired speaker individuality.

### Second Embodiment

Given below is the explanation of a second embodiment. In the first embodiment, the explanation is given on the premise that a speaker parameter value is registered using some other device other than the speech synthesis device. However, if a speaker parameter value can be registered using the speech synthesis device that sets and uses the speaker parameter value, it would lead to enhancement in the user-friendliness. In that regard, in the second embodiment, the speech synthesis device is equipped to have the function of registering the speaker parameters.

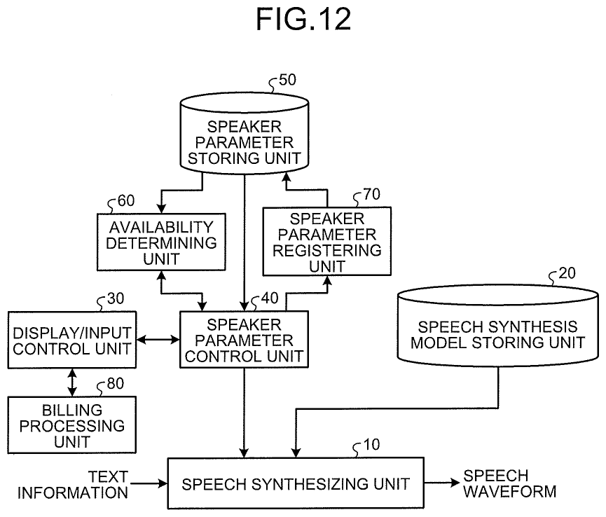

FIG. 12 is a block diagram illustrating an exemplary functional configuration of the speech synthesis device according to the second embodiment. As compared to the configuration illustrated in FIG. 1 according to the first embodiment, the configuration according to the second embodiment differs in the way that a speaker parameter registering unit 70 is added. Moreover, if the user is to be charged for registering the speaker parameter value, then a billing processing unit 80 is further added.

In the second embodiment, using the user interface provided by the display/input control unit 30, a user can check the registrability of the input speaker parameter value and can give a registration request. When a user gives an instruction for checking the registrability, the display/input control unit 30 sends to the speaker parameter control unit 40 the instruction for checking the registrability and information such as the speaker parameter value to be registered and the user information, and then the speaker parameter control unit 40 sends all that information to the availability determining unit 60. In the second embodiment, the availability determining unit 60 has a function for determining the registrability and a function for calculating the registration fee. When the determination of registrability is requested by the speaker parameter control unit 40, the availability determining unit 60 determines the registrability by referring to the speaker parameter storing unit 50, calculates the registration fee in the case in which the speaker parameter value is registrable, and sends the result to the speaker parameter control unit 40. Then, the determination result and the registration fee for a registrable value are sent from the speaker parameter control unit 40 to the display/input control unit 30, and are then notified to the user via the user interface provided by the display/input control unit 30.

Regarding the speaker parameter value determined to be registrable, the user can give a registration request using the user interface provided by the display/input control unit 30. If a registration fee needs to be paid, then the billing processing unit 80 is notified about the registration fee so that it can perform billing with respect to the user. When the receipt of the registration fee is confirmed, the billing processing unit 80 notifies the display/input control unit 30 about the same. Then, the display/input control unit 30 sends the speaker parameter value, the user information, and the information related to the usage condition to the speaker parameter control unit 40. Subsequently, the speaker parameter control unit 40 sends that information along with a registration instruction to the speaker parameter registering unit 70. In response to the registration instruction received from the speaker parameter control unit 40, the speaker parameter registering unit 70 stores the specified speaker parameter value along with the supplementary information such as the user information and the usage condition in the speaker parameter storing unit 50.

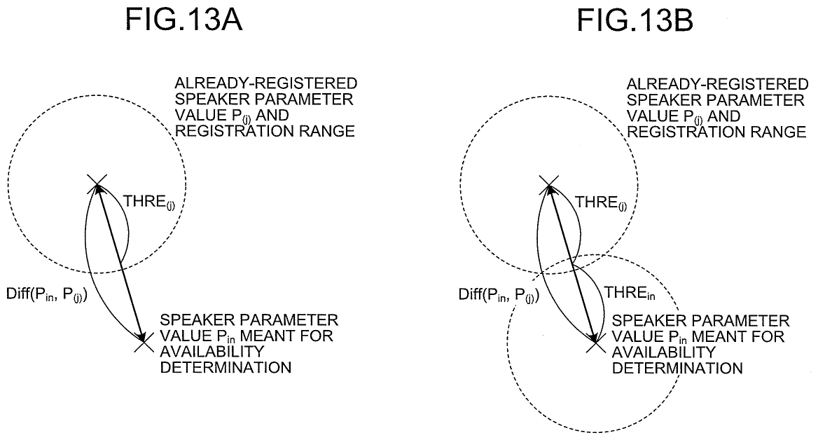

The determination method by which the availability determining unit 60 determines registrability of the speaker parameter value is fundamentally identical to the determination method for determining the availability, except for the difference that the registration range of the speaker parameter value to be registered is taken into account in the registrability determination. The difference between the availability determination and the registration difference is explained with reference to FIGS. 13A and 13B. FIG. 13A is a conceptual diagram of the availability determination, and FIG. 13B is a conceptual diagram of the registrability determination. With reference to FIGS. 13A and 13B, × represents a speaker parameter value; the dotted line represents the registration range of the speaker parameter value; Diff(Pᵢₙ, P₍ⱼ₎) represents the difference between the speaker parameter values; THRE(ⱼ₎ represents a first threshold value indicating a boundary of the registration range of the already-registered speaker parameter value P₍ⱼ₎; and THREᵢₙ represents a second threshold value indicating the registration range of the speaker parameter value Pᵢₙ to be registered. In the availability determination performed with reference to FIG. 13A, it is sufficient to determine whether the speaker parameter value Pᵢₙ is included in the registration range of the already-registered speaker parameter value P₍ⱼ₎. However, in the registrability determination performed with reference to FIG. 13B, it is necessary to take into account the possibility of overlapping of the registration range of the already-registered speaker parameter value P₍ⱼ₎ and the registration range of the speaker parameter value Pᵢₙ to be registered.

In the registrability determination, if overlapping of the registration ranges is not allowed; then, in the determination that is equivalent to Step S107 in the flowchart illustrated in FIG. 5, the availability determining unit 60 uses, for example, the conditional expression given below in Equation (2) and determines that the speaker parameter value is not registrable if Equation (2) is satisfied.

Diff(Pᵢₙ, P₍ⱼ₎)≤(THRE₍ⱼ₎+THREᵢₙ) (2)

Meanwhile, when the registration ranges are overlapping, if the use by the owner of the already-registered speaker parameter value is to be given priority in the overlapped range; then, in an identical manner to the availability determination, the availability determining unit 60 determines registrability using the conditional expression given below in Equation (3). However, if the conditional expression given earlier in Equation (2) is satisfied despite the determination that the speaker parameter value is registrable, then the availability determining unit 60 determines that the speaker parameter value is registrable with an condition. In that case, the availability determining unit 60 gives a notification using the user interface provided by the display/input control unit 30, and makes an inquiry to the user about whether or not to perform registration after adjusting the speaker parameter value and the registration range.

Diff(Pᵢₙ, P₍ⱼ₎)≤(THRE₍ⱼ₎) (3)

For example, the availability determining unit 60 obtains a speaker parameter value Pᵢₙ^{subset} that is adjusted to satisfy Equation (4) given below.

Diff(Pᵢₙ^{subset}, P₍ⱼ₎)>(THRE₍ⱼ₎+THREᵢₙ) (j=0, 1, . . . , C−1) (4)

Then, the availability determining unit 60 sends the adjusted speaker parameter value Pᵢₙ^{subset} to the speaker parameter control unit 40, and requests the speaker parameter control unit 40 to inquire about whether or not to register the adjusted speaker parameter value Pᵢₙ^{subset}. In response to the request, the speaker parameter control unit 40 instructs the display/input control unit 30 to make an inquiry to the user about whether or not to register the adjusted speaker parameter value Pᵢₙ^{subset}. As a result, an inquiry is made to user via the user interface provided by the display/input control unit 30. If the user gives a request for registering the adjusted speaker parameter value Pᵢₙ^{subset}, then the speaker parameter control unit 40 instructs the speaker parameter registering unit 70 to register the adjusted speaker parameter value Pᵢₙ^{subset}.

Alternatively, the availability determining unit 60 can obtain a substitute second threshold value THREᵢₙ^{subset} that is lowered to satisfy Equation (5) given below (i.e., a substitute second threshold value that narrows the registration range of the speaker parameters).

Diff(Pᵢₙ, P₍ⱼ₎)>(THRE₍ⱼ₎+THREᵢₙ^{subset}) (j=0, 1, . . . , C−1) (5)

In that case, the availability determining unit 60 sends the substitute threshold value THREᵢₙ^{subset} to the speaker parameter control unit 40, and requests the speaker parameter control unit 40 to inquire about whether or not to register the speaker parameter value Pᵢₙ with a narrower registration range. In response to the request, the speaker parameter control unit 40 instructs the display/input control unit 30 to make an inquiry to the user about whether or not to register the speaker parameter value Pᵢₙ with a narrower registration range. As a result, an inquiry is made to the user via the user interface provided by the display/input control unit 30. If the user gives a request for registering the speaker parameter value Pᵢₙ with a narrower registration range, then the speaker parameter control unit 40 instructs the speaker parameter registering unit 70 to register the speaker parameter value Pᵢₙ with a narrower registration range.

When the speaker parameter value to be registered is determined to be registrable, the availability determining unit 60 calculates the registration fee of that speaker parameter value to be registered. For example, based on the distribution of the already-registered speaker parameter values stored in the speaker parameter storing unit 50, the availability determining unit 60 can calculate the registration fee that is higher in proportion to the popularity of the speaker individuality. That is, the availability determining unit 60 decides on the registration fee according to the number of already-registered speaker parameter values positioned in the surrounding area of the speaker parameter value to be registered. More particularly, regarding a predetermined difference D_{adj}, the number of such speaker parameter values P₍ⱼ₎ is obtained for which Equation (6) given below is satisfied, and the registration fee is calculated using a function that monotonically increases with respect to the number of speaker parameter values P₍ⱼ₎.

Diff(Pᵢₙ, P₍ⱼ₎)≤D_{adj} (6)

Alternatively, the registration fee can be calculated not only by taking into account the already-registered speaker parameter values but also by taking into account the usage frequency of the input speaker parameter value or the surrounding values thereof. In that case, history information of the parameter values used by all users is also stored in the speaker parameter storing unit 50.

Given below is the explanation of an example of the interactive operations related to the registration of speaker parameters as performed by the speech synthesis device, along with explaining a specific example of the user interface that is provided by the display/input control unit 30 to the user.

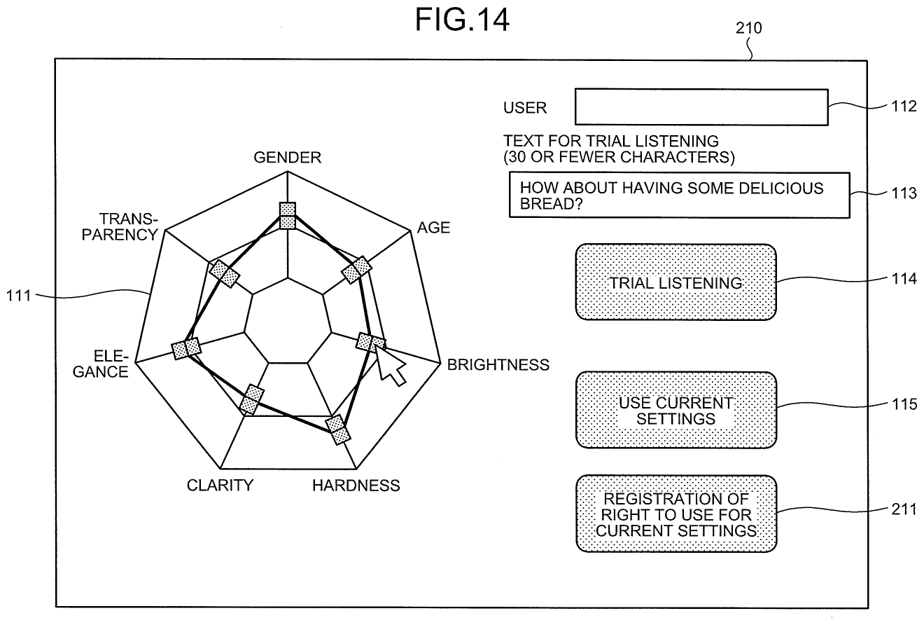

In the second embodiment, when a user performs an operation for selecting the option of “created speaker individuality” from the pulldown menu 102 in the screen 100 illustrated in FIG. 6, the screen 100 illustrated in FIG. 6 changes to a screen 210 illustrated in FIG. 14. The screen 210 illustrated in FIG. 14 is configured by adding, in the screen 110 illustrated in FIG. 7, a “registration of right to use for current settings” button 211 meant for confirming the registrability of the speaker parameter value.

After inputting the desired speaker parameter value using the radar chart 111 in the screen 210 illustrated in FIG. 14, when the user presses the “registration of right to use for current settings” button 211, the speaker parameter value and the user information as input by the user and an instruction for confirming the registrability are sent from the display/input control unit 30 to the speaker parameter control unit 40. Then, the speaker parameter control unit 40 sends the speaker parameter value, which is received from the display/input control unit 30, to the availability determining unit 60 and requests for the determination of registrability of the speaker parameter value. In response to the request received from the speaker parameter control unit 40, the availability determining unit 60 determines the registrability of the speaker parameter value according to, for example, the method described earlier, and sends the determination result to the speaker parameter control unit 40.

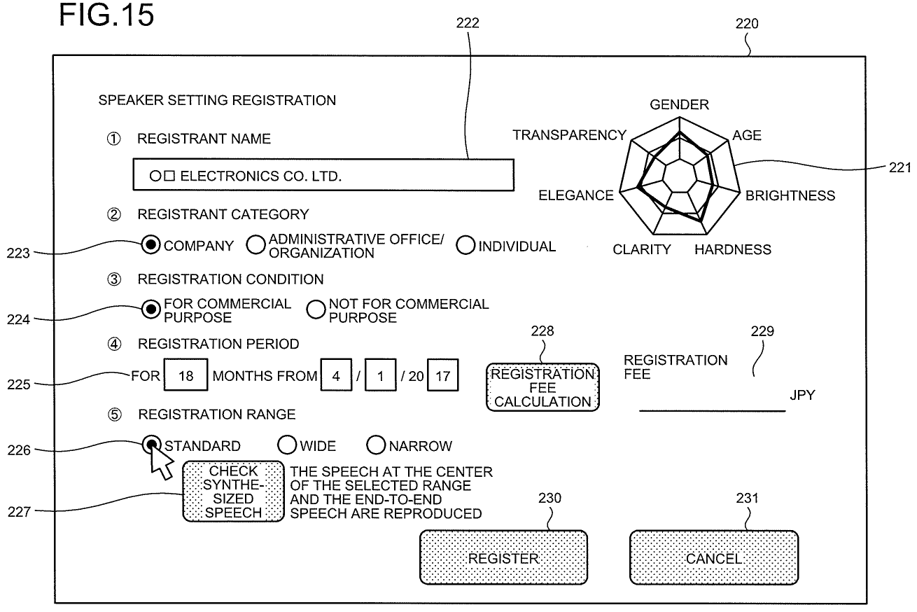

If the determination result obtained by the availability determining unit 60 indicates that the speaker parameter value is registrable, then the speaker parameter control unit 40 notifies the display/input control unit 30 about the confirmation result indicating that the speaker parameter value is registrable; and the screen on the user interface changes from the screen 210 illustrated in FIG. 14 to a screen 220 illustrated in FIG. 15. The screen 220 illustrated in FIG. 15 is meant to enable the user to give a registration request for registering the speaker parameter value, and includes the following: a thumbnail 221 of a radar chart indicating the speaker parameter value to be registered; a text box 222 for inputting the registrant name; a checkbox for selecting the registrant category; a text box 224 for inputting the registration condition; an input column 225 for inputting the registration period; a checkbox 226 for selecting the registration range; a “speech synthesis for checking” button 227 that is meant for checking the synthetic speech obtained when a speaker parameter value present in the registration range selected using the checkbox 226 is applied; a “registration fee calculation” button 228 for instructing calculation of the registration fee; a registration fee display area 229 in which the calculated registration fee is displayed; a “register” button 230 for issuing a registration request; and a “cancel” button 231 for instructing cancellation of the registration.

The user can input a variety of information, which is required in the registration of a speaker parameter value, in the screen 220 illustrated in FIG. 15. For example, using the checkbox 226, the user can select the registration range of the speaker parameter value. The registration range of the speaker parameter value corresponds to the first threshold value described earlier, and usually the registration fee becomes relatively high or relatively low in proportion to the widening or narrowing of the registration range. In the case of such a configuration, at the time of registering a speaker parameter value, the first threshold value representing a boundary of the selected registration range is stored as supplementary information in the speaker parameter storing unit 50.

When the user presses the “registration fee calculation” button 228, the registration fee calculated by the availability determining unit 60 gets displayed in the registration fee display area 229. The user can refer to the registration fee displayed in the registration fee display area 229, and decide on whether or not to give a registration request. Subsequently, when the user presses the “register” button 230, the billing processing unit 80 performs billing. When the receipt of the registration fee is confirmed, the speaker parameter registering unit 70 performs a registration operation for registering the speaker parameter value in response to the registration instruction received from the speaker parameter control unit 40; and the speaker parameter value to be registered and the supplementary information are stored in the speaker parameter storing unit 50. Meanwhile, if the user presses the “cancel” button 231, the registration operation for registering the speaker parameter value is cancelled, and the screen returns to the screen 210 illustrated in FIG. 14.

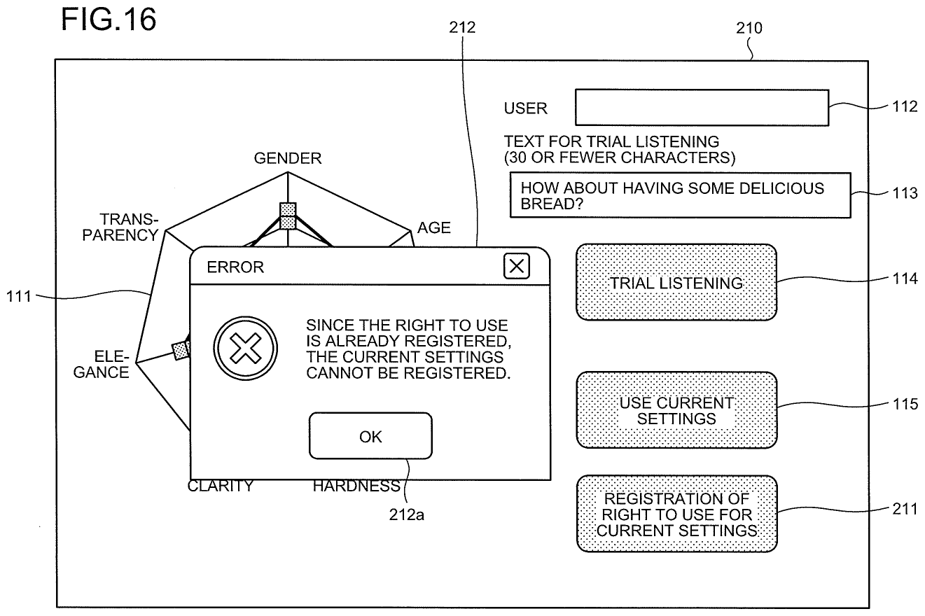

If the determination result obtained by the availability determining unit 60 indicates that the speaker parameter value is not registrable, then the speaker parameter control unit 40 notifies the display/input control unit 30 about the confirmation result indicating that the speaker parameter value is not registrable. In that case, for example, as illustrated in FIG. 16, the display/input control unit 30 displays, on the screen 210, a popup error message 212 notifying the user that the speaker parameter value cannot be registered. When an “OK” button 212a provided in the error message 212 is pressed, the screen returns to the screen 210 illustrated in FIG. 14.

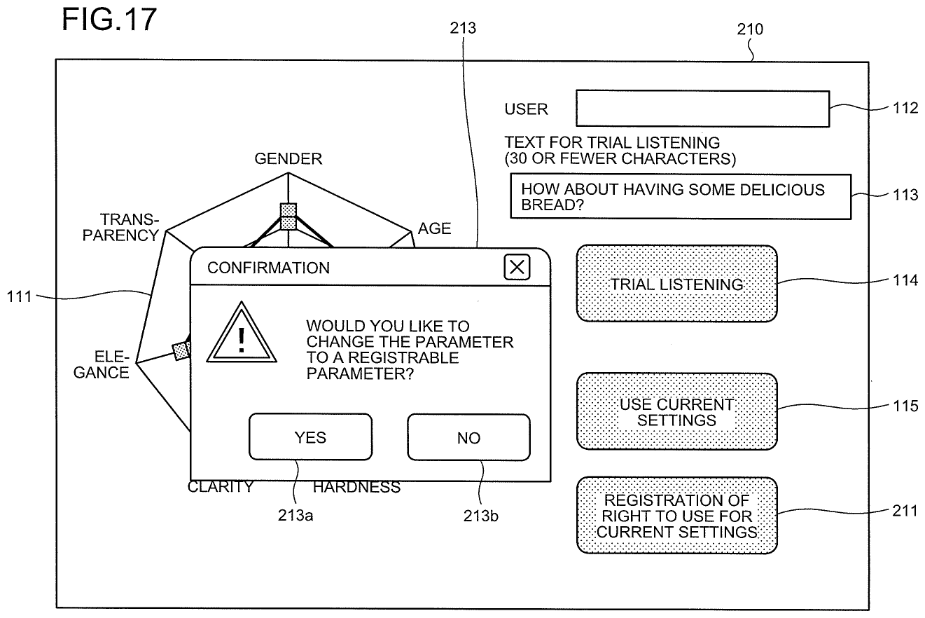

If the determination result indicates that the speaker parameter value is registrable with an condition, the availability determining unit 60 calculates the adjusted speaker parameter value as described earlier, and requests the speaker parameter control unit 40 to inquire about whether or not to register the adjusted speaker parameter value. Then, the speaker parameter control unit 40 instructs the display/input control unit 30 to inquire about whether or not to register the adjusted speaker parameter value. In that case, for example, as illustrated in FIG. 17, the display/input control unit 30 displays, on the screen 210, a popup confirmation message 213 as an inquiry about whether or not to register the adjusted speaker parameter value. If a “yes” button 213a that is provided in the confirmation message 213 is pressed, then the screen changes to the screen 220 illustrated in FIG. 15. However, if a “no” button 213b that is provided in the confirmation message 213 is pressed, then the screen returns to the screen 210 illustrated in FIG. 14.

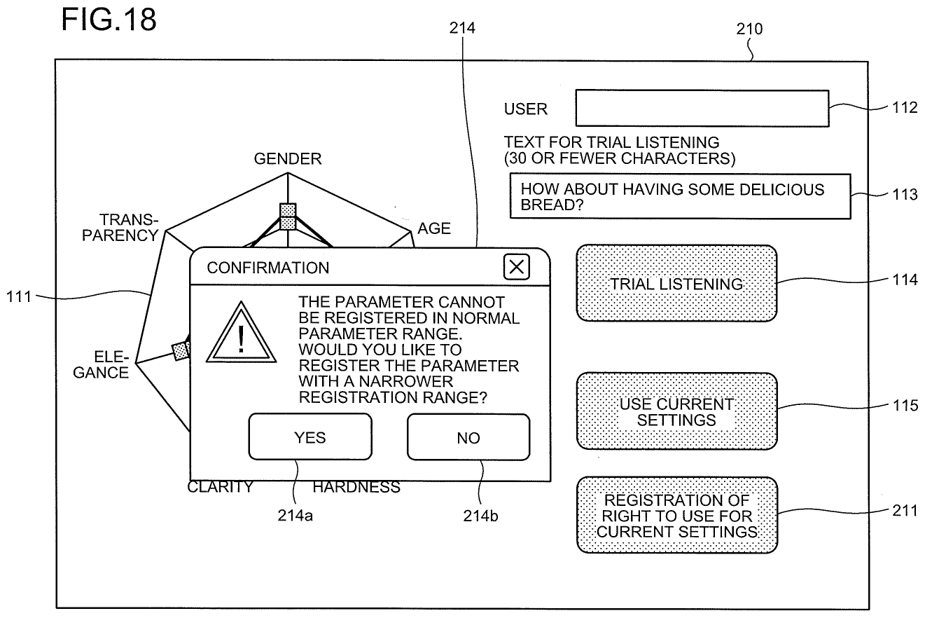

Alternatively, if the determination result indicates that the speaker parameter value is registrable with an condition, the availability determining unit 60 can obtain a substitute plan for narrowing the registration range of the speaker parameters as described earlier, and can request the speaker parameter control unit 40 to inquire about whether or not to register the speaker parameter value with a narrower registration range. In that case, for example, as illustrated in FIG. 18, the display/input control unit 30 displays, on the screen 210, a popup confirmation message 214 as an inquiry about whether or not to register the speaker parameter value with a narrower registration range. When a “yes” button 214a that is provided in the confirmation message 214 is pressed, the screen changes to the screen 220 illustrated in FIG. 15. At that time, in the screen 220, the checkbox 226 that is meant for selecting the registration range is fixed to the option “narrow”. Meanwhile, if a “no” button 214b that is provided in the confirmation message 214 is pressed, then the screen returns to the screen 210 illustrated in FIG. 14.

As described above, according to the second embodiment, registration of the speaker parameter value is also possible in response to the user operations, thereby enabling achieving enhancement in the user-friendliness. Moreover, the billing of the registration fee, which is required for the registration of the speaker parameters, can also be performed in an appropriate manner.

In the second embodiment related to the registration of a speaker parameter value, the explanation is given about the mechanism of billing performed at the time of registration. However, also in the first embodiment that is related to the use of the synthetic speech in which the speaker parameter value is used, a mechanism can be provided for enabling billing at the time of usage. In that case, the usage fee can be set by providing, in the registration conditions regarding the speaker parameter value, an item enabling usage fee setting by a different person. For example, in an identical manner to the registration range, a plurality of fee patterns including the charge-free option can be set, and can be made selectable or can be made freely settable by the registrant. The setting value of this item can be stored, for example, in the speaker parameter storing unit 50 as part of the information illustrated in FIG. 4; and, at the time of determination performed by the availability determining unit 60, based on the condition set in the corresponding speaker individuality ID, the usage fee can be notified to the user by displaying it along with the availability. In the case of using the speaker parameter value having the usage fee set therein, it can be dealt using the billing function in an identical manner to the case of registration.

### Third Embodiment

Given below is the explanation of a third embodiment. In the first embodiment described earlier, the difference between the input speaker parameter value and the already-registered speaker parameter value is obtained using the speaker parameter value itself. However, in that case, if updating of the speech synthesis model results in changes in the definitions of the speaker parameters or changes in the types of the values; a speaker parameter value before the changes cannot be compared with a speaker parameter value after the changes, and the speaker parameter value registered before the changes becomes unusable after the changes. In that regard, in the third embodiment, at the time of obtaining the difference between the input speaker parameter value and the already-registered speaker parameter value, instead of using the actual value, the speaker parameter value to be compared is mapped onto some other common parameter space, and the difference is calculated in that parameter space.

The speech synthesis device according to the third embodiment has an identical configuration to the configuration illustrated in FIG. 1 according to the first embodiment or the configuration illustrated in FIG. 12 according to the second embodiment. However, in the third embodiment, at the time of calculating the difference between the input speaker parameter value and the already-registered speaker parameter value, the availability determining unit 60 maps the speaker parameter values to be compared onto a common parameter space. Then, the availability determining unit 60 calculates the difference in that parameter space.

If P₁^{SA} and P₂^{SB} (in parameter spaces SA and SB, respectively) represent the speaker parameter values to be compared, and if map^{SA→SX}( ) and map^{SB→SX}( ) represent the functions for mapping the speaker parameter values onto a common parameter space SX; then the difference Diff(P₁^{SA}, P₂^{SB}) between those speaker parameter values is calculated in the mapped space as given below in Equation (7).

Diff(P₁^{SA}, P₂^{SB})=Diff^{SX}(map^{SA→SX}(P₁^{SA}), map^{SB→SX}(P₂^{SB})) (7)

Where, Diff^{SX} represents the difference between the speaker parameters mapped onto the parameter space SX.

As a result of implementing such a method, the difference can be calculated even between the speaker parameter values having different definitions or different types of values. Moreover, also among the speaker parameter values having the same definition and the same type of values, if the mapping destination space represents the speaker individuality in a more direct manner than the original speaker parameter spaces, a more appropriate difference can be calculated according to this particular method. For example, as the speaker parameter space representing the mapping destination, a general-purpose parameter space such as the vector space of the logarithmic amplitude spectrum can be used that expresses the speaker individuality in a direct manner and can be calculated from various speaker parameter values.

Supplementary Explanation

The speech synthesis device according to the embodiments described above can be implemented using, for example, a general-purpose computer as the fundamental hardware. That is, the functions of the speech synthesis device according to the embodiments described above can be implemented by making the processor installed in a general-purpose computer execute computer programs. At that time, the speech synthesis device can be implemented by installing the computer programs in advance in the computer, or can be implemented by storing the computer programs in a memory medium such as a CD-ROM or distributing the computer programs via a network, and then installing them in the computer.

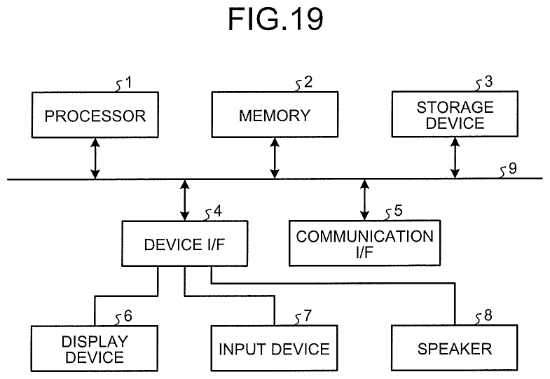

FIG. 19 is a block diagram of an exemplary hardware configuration of the speech synthesis device. For example, as illustrated in FIG. 19, the speech synthesis device has the hardware configuration of a commonly-used computer that includes a processor 1 such as a central processing unit (CPU); a memory 2 such as a random access memory (RAM) or a read only memory (ROM); a storage device 3 such as a hard disk drive (HDD) or a solid state drive (SSD); a device I/F 4 that enables establishing connection with a display device 6 such as a liquid crystal display, an input device 7 such as a keyboard, a mouse, or a touch-sensitive panel, and a loudspeaker 8 that outputs sound; a communication I/F 5 that performs communication with the outside; and a bus 9 that connects the constituent elements to each other.

When the speech synthesis device has the hardware configuration as illustrated in FIG. 19, for example, the processor 1 reads the computer programs stored in the storage device 3 and executes then using the memory 2, and resultantly becomes able to implement the functions of the speech synthesizing unit 10, the display/input control unit 30, the speaker parameter control unit 40, the availability determining unit 60, the speaker parameter registering unit 70, and the billing processing unit 80. Moreover, the speech synthesis model storing unit 20 and the speaker parameter storing unit 50 can be implemented using the storage device 3.

Alternatively, the functions of some or all of the constituent elements of the speech synthesis device can be implemented using dedicated hardware such as an application specific integrated circuit (ASIC) or a field-programmable gate array (FPGA) (i.e., using a dedicated processor instead of a general-purpose processor). Still alternatively, the functions of the constituent elements can be implemented using a plurality of processors.

Still alternatively, the speech synthesis device according to the embodiments can be configured as a system in which the functions of the constituent elements are implemented in a dispersed manner among a plurality of computers. Still alternatively, the speech synthesis device according to the embodiments can be a virtual machine that runs in a cloud system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech synthesis device comprising:
a speech synthesizing unit that, based on a speaker parameter value representing a set of values of parameters related to speaker individuality, is capable of controlling the speaker individuality of synthesized speech;
a speaker parameter storing unit that is used to store an already-registered speaker parameter value;
an availability determining unit that, based on a result of comparing an input speaker parameter value with each already-registered speaker parameter value, determines availability of the input speaker parameter value; and
a speaker parameter control unit that prohibits or restricts use of the input speaker parameter value that is determined to be unavailable by the availability determining unit.

2. The speech synthesis device according to claim 1, further comprising a speech synthesis model storing unit that is used to store a speech synthesis model including a base model obtained by modeling base speaker individuality and a speaker individuality control model obtained by modeling features of factors of speaker individuality, wherein
the speech synthesizing unit
comprises a selecting unit that selects a plurality of statistical values from the base model and the speaker individuality control model,
comprises an adding unit that, according to a specified speaker parameter value, performs weighted addition of the statistical values, and
generates a speech waveform of the synthesized speech using the statistical values for which the weighted addition is performed by the adding unit.

3. The speech synthesis device according to claim 1, wherein the availability determining unit
calculates a difference between the input speaker parameter value and an already-registered speaker parameter value using a given function, and
if the calculated difference is equal to or smaller than a first threshold value indicating a boundary of a registration range of the already-registered speaker parameter value, determines that the input speaker parameter value is unavailable.

4. The speaker synthesis device according to claim 3, wherein the speaker parameter storing unit is used to further store the first threshold value specific to the already-registered speaker parameter value.

5. The speech synthesis device according to claim 3, wherein the availability determining unit
maps the input speaker parameter value and the already-registered speaker parameter value onto a common speaker parameter space, and
calculates the difference between the input speaker parameter value and the already-registered speaker parameter value in the common speaker parameter space.

6. The speech synthesis device according to claim 1, further comprising a speaker parameter registering unit that registers the input speaker parameter value in the speaker parameter storing unit, wherein
in response to a registration request by a user, the speaker parameter control unit gives a registration instruction to the speaker parameter registering unit for registering a speaker parameter value.

7. The speech synthesis device according to claim 6, wherein
the availability determining unit further determines registrability of the input speaker parameter value, and
when the availability determining unit determines that the input speaker parameter value is registrable, the speaker parameter control unit gives a registration instruction to speaker parameter registering unit for registering the input speaker parameter value.

8. The speech synthesis device according to claim 7, wherein the availability determining unit
calculates a difference between the input speaker parameter value and the already-registered speaker parameter value using a given function, and
if the calculated difference is equal to or smaller than a third threshold value that is obtained by adding a second threshold value indicating a registration range of the input speaker parameter value to a first threshold value indicating a boundary of a registration range of the already-registered speaker parameter value, determines that the input speaker parameter value is unavailable.

9. The speech synthesis device according to claim 8, wherein
when there is an already-registered speaker parameter value whose difference from the input speaker parameter value is greater than the first threshold value but equal to or smaller than the third threshold value, the availability determining unit makes an inquiry to the user about whether or not to register the speaker parameter value that is adjusted to have the difference to be greater than the third threshold value, and
when the registration request for registering the adjusted speaker parameter value is received from the user, the parameter control unit gives the registration instruction to the speaker parameter registering unit for registering the adjusted speaker parameter value.

10. The speech synthesis device according to claim 8, wherein
when there is an already-registered speaker parameter value whose difference from the input speaker parameter value is greater than the first threshold value but equal to or smaller than the third threshold value, the availability determining unit makes an inquiry to the user about whether or not to register the input speaker parameter value by narrowing the registration range of the input speaker parameter value, and
when the registration request for registering the speaker parameter value having a narrowed registration range is received from the user, the parameter control unit gives the registration instruction to the speaker parameter registering unit for registering the speaker parameter value having the narrowed registration range.

11. The speech synthesis device according to claim 6, wherein
the availability determining unit further calculates a registration fee when registering the speaker parameter value, and
the speech synthesis device further comprises a billing processing unit that, when the speaker parameter value is registered in the speaker parameter storing unit, performs billing based on the registration fee.

12. The speech synthesis device according to claim 11, wherein the availability determining unit calculates the registration fee based on a relationship between the speaker parameter value to be registered and a distribution of already-registered speaker parameter values.

13. The speech synthesis device according to claim 1, wherein the speaker parameter storing unit is used to further store at least one of information on an owner of the already-registered speaker parameter value and information related to a usage condition.

14. A speech synthesis method implemented in a speech synthesis device that, based on a speaker parameter value representing a set of values of parameters related to speaker individuality, is capable of controlling the speaker individuality of synthesized speech, the speech synthesis method comprising:
determining, based on a result of comparing an input speaker parameter value with each already-registered speaker parameter value, availability of the input speaker parameter value; and
prohibiting or restricting use of the input speaker parameter value that is determined to be unavailable.

15. A computer program product having a computer readable medium including instructions, wherein the instructions, when executed by a computer, cause the computer to function as a speech synthesis device that, based on a speaker parameter value representing a set of values of parameters related to speaker individuality, is capable of controlling the speaker individuality of synthesized speech, the computer program product causing the computer to perform:
determining, based on a result of comparing an input speaker parameter value with each already-registered speaker parameter value, availability of the input speaker parameter value; and
prohibiting or restricting use of the input speaker parameter value that is determined to be unavailable.
